(19) United States
(12) Patent Application Publication
(10) Pub. No.: US 2025/0059810 A1
(43) Pub. Date: Feb. 20, 2025

(54) METHOD FOR INSTALLING A FURNITURE DRIVE

(71) Applicant: Julius Blum GmbH, Hoechst (AT)

(72) Inventor: Simon LUBETZ, Hoechst (AT)

(21) Appl. No.: 18/935,998

(22) Filed: Nov. 4, 2024

Related U.S. Application Data
(63) Continuation of application No. PCT/AT2023/060122, filed on Apr. 12, 2023.

(30) Foreign Application Priority Data
May 5, 2022 (AT) 50310/2022

(51) Int. Cl. E05D 11/00

(52) U.S. Cl. CPC E05D 11/0054; E05Y 2600/56; E05Y 2900/20

(57) ABSTRACT

A method for installing a furniture drive including a drive unit and a covering cap for at least partially covering a lateral visible region of the furniture drive, on a furniture carcass having a furniture carcass side wall and a furniture carcass top panel. The method includes, to preferably be performed in chronological order: moving the covering cap into a position to make contact with the furniture carcass top panel and optionally the furniture carcass side wall, such that the covering cap forms an installation stop for the furniture drive for height setting purposes, and moving the drive unit into a position in which the drive unit makes contact with the covering cap such that the drive unit is vertically spaced from the furniture carcass top panel at a specified installation position on the furniture carcass.

The present application is a continuation of International Application PCT/AT2023/060122 filed on Apr. 12, 2023. Thus, all of the subject matter of International Application PCT/AT2023/060122 is incorporated herein by reference.

### BACKGROUND OF THE INVENTION

The invention relates to a method for installing a furniture drive, in particular flap drive, comprising a drive unit and a covering cap for covering a lateral visible area of the furniture drive at least in areas, on a furniture carcass with a furniture carcass side wall and a furniture carcass top panel. The invention furthermore relates to the use of a covering cap of a furniture drive. In addition, the invention relates to an installation arrangement consisting of at least one furniture drive, in particular flap drive, for moving a movably mounted furniture part relative to a furniture carcass, comprising a drive unit and a covering cap, and a furniture carcass with a furniture carcass side wall and a furniture carcass top panel. In addition, the invention relates to a covering cap as well as a further installation stop for installing a furniture drive, in particular flap drive, on or in a furniture carcass, comprising at least one first locating point for setting the depth of a drive unit relative to a furniture carcass side wall.

A method for positioning a furniture drive relative to a furniture carcass is already known from the document WO 2018/140991 A1, wherein an installation stop firmly connected to the furniture drive is provided, which is pivotable relative to the furniture drive during an installation operation, in order to be able to obtain a defined spacing of the furniture drive from a front face of a furniture carcass side wall-a depth setting. The furniture drive comprises two stops that are separate from each other and spaced apart from each other, in order to be able to obtain a defined spacing of the furniture drive from a furniture carcass top panel-a height setting. A covering cap can be provided, which at least partially covers the installation stop or a lateral visible area of the furniture drive.

A disadvantage of the state of the art is that the two stops that are separate and spaced apart from each other can cause a non-parallel alignment of the furniture drive relative to the furniture carcass top panel, for example due to component tolerances and/or an incorrect fastening to the furniture drive, which causes a reduced functionality of the furniture drive-in particular in the case of furniture drives arranged on both sides of the furniture carcass. Moreover, a plurality of additional component parts are necessary for the height setting (in particular in combination with the depth setting). Moreover, the height setting is limited with regard to a geometric design of the stops as an integral part of the furniture drive. Furthermore, the stops are only suitable to a minor extent for spacings from the furniture carcass top panel, as a result of which a wide range of areas of application are not covered by the stops. In addition, the depth setting is also restricted to the structural size of the installation stop as an integral part of the furniture drive, wherein the installation stop first needs to be brought into the correct pivot position by the installer. Furthermore, the installation stop spoils the front-side esthetic appearance of the furniture drive, with the result that the installation stop is possibly to be covered by the covering cap.

Installation arrangements of furniture drives are known from the documents WO 2022/082240 A1, EP 2 331 783 A1 as well as CN 216130737 U.

### SUMMARY OF THE INVENTION

The objective technical problem to be addressed by the present invention is therefore to specify a method improved compared with the state of the art, an installation arrangement, a covering cap as well as a further installation stop, in which the disadvantages of the state of the art are at least partially remedied, and which is characterized in particular by a simplified installation of the furniture drive on the furniture carcass.

According to the invention, therefore the following method steps are carried out, in particular in chronological order:
moving the covering cap into a position in which the covering cap contacts the furniture carcass top panel and possibly the furniture carcass side wall, with the result that the covering cap forms an installation stop for the furniture drive for the height setting, and
moving the drive unit into a position in which the drive unit contacts the covering cap preferably arranged against the furniture carcass top panel.

The result is that the drive unit is arranged at a predetermined vertical distance from the furniture carcass top panel in a prespecified installation position on the furniture carcass.

This makes it possible first of all for the covering cap to have a dual function. The covering cap on the one hand improves the esthetic appearance of the furniture drive and protects the furniture drive from contaminants, and on the other hand serves as an installation stop or gage in the installation of the furniture drive on the furniture carcass.

In general, it is discretionary whether the covering cap is first positioned on the furniture carcass and then the drive unit is arranged on the covering cap or whether the covering cap is first brought into contact with the drive unit and then the drive unit is arranged together with the covering cap on the furniture carcass.

Through the use of the covering cap, no additional component parts are necessary for the height setting, wherein larger spacings of the furniture drive from the furniture carcass top panel with defined alignment are in particular also able to be guaranteed. The risk of a skewed arrangement of the furniture drive on the furniture carcass is significantly reduced, wherein a correct positioning of the furniture drive for optimum functionality of the furniture drive-in particular in the case of a plurality of furniture drives—can be ensured.

Added to this is the positive property that drilled holes need not be provided in the furniture carcass—in particular not for different installation positions-before the furniture drive is installed and the drilled holes for fastening the furniture drive to the furniture carcass, with which the furniture drive can be arranged in a positionally stable manner on the furniture carcass, can be introduced flexibly and individually with regard to the desired requirements of the furniture drive in the course of the process of installing the furniture drive on the furniture carcass. Moreover, no, in particular predefined and/or preinstalled, plug-in connectors or the like, with which the furniture drive is fixed inside the drilled holes in the course of the installation, are necessary on the furniture drive.

The term “furniture carcass top panel” is to be interpreted broadly such that a partition for subdividing the furniture carcass into two furniture parts lying vertically one above the other can also be regarded as a furniture carcass top panel.

The prespecified installation position (generally only virtually present on the furniture carcass before installation) with respect to the height setting can be contingent on a height of the covering cap.

The covering cap can generally also be formed multi-part, wherein, for example, a first part of the covering cap is preinstalled on the furniture drive and a second part is fastened, preferably releasably, to the furniture drive or the drive unit after the furniture drive has been installed on the furniture carcass. The heights of the plurality of covering cap parts can for example be matched to the desired height setting of the furniture drive. A height of the covering cap can relate to the whole covering cap or a part of the covering cap.

As stated at the beginning, protection is also sought for a use of a covering cap of a furniture drive, in particular flap drive, as an installation stop for installing the furniture drive on a furniture carcass.

The installation stop can also synonymously be called a gage.

The covering cap can generally also be suitable for covering a front side on the face, an underside and/or a top side of the drive unit—for example by overlapping lateral edges.

As stated at the beginning, protection is also sought for an installation arrangement consisting of at least one furniture drive, in particular flap drive, for moving a movably mounted furniture part relative to a furniture carcass, comprising a drive unit and a covering cap, and a furniture carcass with a furniture carcass side wall and a furniture carcass top panel. The covering cap is arranged against the furniture carcass top panel and the drive unit is arranged on the covering cap for the height setting during an installation of the drive unit on the furniture carcass at a predetermined vertical distance from the furniture carcass top panel in a prespecified installation position.

As stated at the beginning, protection is also sought for a covering cap for installing a furniture drive, in particular flap drive, on a furniture carcass. The covering cap comprises at least one fastening device for arranging the covering cap in an operating position in which the covering cap is arranged, preferably parallel, in the use position, to the side of a drive unit and an adjustment means for arranging the covering cap in a further operating position in which the covering cap is arranged in an adjustment device of the drive unit, in the use position, above the drive unit.

Through the combination of the at least one fastening device and the adjustment means, an exact positioning in order to install the furniture drive via the covering cap for the purpose of installation as well as the subsequent concealment, at least in areas, of a lateral visible area of the furniture drive can be effected. The at least one fastening device can be present, for example, in the form of a clip connection for the connection to the drive unit, wherein other fastening devices such as a screw connection are also conceivable.

The adjustment means is particularly preferably formed corresponding to the adjustment device of the drive unit—for example in the form of a bar which can be engaged in a depression of the drive unit. The adjustment means can generally also be formed, alternatively or in addition, as a longitudinal edge which preferably leads to an inclined surface of the covering cap, in order to arrange the covering cap against the furniture carcass top panel linearly in the course of the installation.

As stated at the beginning, protection is also sought for a further installation stop for installing a furniture drive, in particular flap drive, on or in a furniture carcass, comprising at least one first locating point for setting the depth of a drive unit relative to a furniture carcass side wall. The further installation stop is releasably fastenable to a drive unit of the furniture drive and is elastically deformable at least in areas for the non-destructive removal from the drive unit.

For the installation of the furniture drive, the further installation stop can function in the sense of a gage for the positioning of the furniture drive relative to the furniture carcass in the case of depth settings and possibly in the case of height settings, as a result of which a precise positioning of the furniture drive in the prespecified installation position can be guaranteed.

Through the releasable fastening to the drive unit, a recyclability of the at least one further installation stop is made possible, wherein material costs are saved, the environment is protected, a furniture drive with a reduced number of component parts is obtained and additional installation space is made available inside and/or outside the furniture drive.

In this context, elastic can be interpreted by a reversible flexible deformation from a first geometric state into a second geometric state without plastic deformation. As a result, the further installation stop can be removed from the furniture drive without requiring at least a partial disassembly of the furniture drive and/or the drive unit. A Young's modulus of the solid material in the range of a plastic (such as for example PET, PU, PVC, PS or the like, with a lower Young's modulus than metallic materials) is particularly preferred, wherein an elasticity similar to rubber is also conceivable.

According to an advantageous design of the invention, on the furniture drive, at least one further installation stop is releasably fastened to the drive unit, preferably via at least one spring clip arranged on the at least one further installation stop, and the drive unit is moved into a position in which the at least one further installation stop contacts the furniture carcass side wall via at least one first locating point for the depth setting, with the result that the drive unit is positioned, in terms of depth, in a prespecified installation position on the furniture carcass.

Through the at least one spring clip, the at least one further installation stop can conveniently be releasably preinstalled on the furniture drive and/or removed from the furniture drive in a user-friendly manner after installation has taken place. Through the at least one further furniture stop, a precise positioning of the furniture drive on the furniture carcass can be effected in two orthogonal spatial directions.

Advantageously, the drive unit is fastened to the furniture carcass in the prespecified installation position, preferably by at least one fastening means such as a screw or dowel, wherein it is preferably provided that the at least one fastening means is inserted into an opening of the drive unit in the course of the installation of the furniture drive, in order to connect the furniture drive to the furniture carcass side wall.

Once the furniture drive has been fixed to the furniture carcass via the at least one fastening means, the covering cap can be transferred into the second functional position and/or the at least one further furniture stop can be removed from the furniture drive, in order to be able to initiate the operation of the furniture drive.

For example, the at least one fastening means can be present in the form of a Spax screw. A preinstallation of the at least one fastening means on the drive unit and/or a predrilled hole in the furniture carcass is not strictly necessary.

It has proved to be favorable that the at least one further installation stop is removed from the drive unit after the furniture drive has been fastened to the furniture carcass. Preferably, the at least one further installation stop is elastically deformed for the removal via at least one cutout.

Due to the flexibility of the at least one further installation stop brought about via the at least one cutout, a time-efficient release of the at least one further installation stop can be effected in one work step. The at least one further installation stop can be used in further furniture drives.

According to an advantageous embodiment of the invention, the covering cap is arranged at least in areas on the lateral visible area of the furniture drive, preferably on the drive unit, after the furniture drive has been fastened to the furniture carcass. Preferably, the covering cap is pivoted from the furniture carcass side wall, substantially through 180° relative to a longitudinal extent of the covering cap, onto the furniture drive and/or, from an installation position in which the covering cap is arranged parallel above the drive unit, is arranged in an operating position in which the covering cap is positioned parallel, to the side of the drive unit.

Adaptations to the covering cap in order to generate the dual function are generally not necessary, wherein no additional stops or gages need to be used for the installation. The operating position can be obtained, for example, via fastening means such as a clip connection. The installation position can be obtained, for example, via an adjustment device.

It has proved to be advantageous that the covering cap has a height, in the use position of the furniture drive on the furniture carcass, which corresponds exactly to a spacing of the drive unit from the furniture carcass top panel for a positioning of the drive unit in the prespecified installation position.

It is generally conceivable that the covering cap is formed height-adjustable, with the result that variable spacings of the furniture drive from the furniture carcass top panel can be set and at the same time a fastening to furniture drives with defined or variable geometry is made possible.

An advantageous variant of the present invention is that the covering cap has two longitudinal edges oriented parallel to each other, with which the drive unit is aligned parallel to the furniture carcass top panel. Preferably, at least one of the two longitudinal edges is arranged directly adjoining an inclined surface of the covering cap and/or against the furniture carcass top panel for the removal of the covering cap after the furniture drive has been fastened to the furniture carcass.

Particularly preferably, the covering cap has a bar and/or an underside aligned parallel to the drive unit during the installation of the furniture drive, which is arranged at least in areas in an adjustment device, preferably indentation, of the drive unit.

Through the underside oriented parallel inside the adjustment device, an undesired tilting of the covering cap relative to the drive unit is stopped and/or a defined locating surface for the positioning of the furniture drive is brought about. The bar can for example protrude transverse from the underside and/or be arranged orthogonal to the underside.

Furthermore, preferably the covering cap contacts the furniture carcass top panel and/or the furniture carcass side wall linearly, via at least two contacting points spaced apart from each other and/or over the surface and/or the drive unit contacts the covering cap linearly, via at least two contacting points spaced apart from each other and/or over the surface.

In an embodiment of the invention, the furniture drive comprises an actuator for moving the movable furniture part by the application of force via the drive unit and/or the covering cap is arranged preferably flat against the furniture carcass side wall.

Force can be applied to the actuator via the drive unit in order to move the movable furniture part. The actuator can for example be present in the form of an actuating arm—possibly in connection with a lever mechanism.

The actuator can generally have a multi-part structure and/or be directly or indirectly connected—for example via a connection via further levers and/or fittings—to a furniture part movably mounted on the furniture carcass.

Through an arrangement of the covering cap flat against the furniture carcass side wall, a defined spacing from the furniture carcass top panel can be favored, wherein a tilting of the covering cap is prevented.

According to a preferred embodiment of the invention, the covering cap has a bar and/or an underside aligned parallel to the drive unit, which is arranged at least in areas in an adjustment device, preferably indentation, of the drive unit. Preferably, the covering cap, from an installation position in which the covering cap is arranged parallel above the drive unit, can be arranged in an operating position in which the covering cap is positioned parallel, to the side of the drive unit.

Furthermore, preferably at least one further installation stop can be attached to the furniture carcass and provided on the at least one drive unit, wherein the at least one further installation stop is preinstalled releasably on the drive unit.

This can make it possible to set the height and depth of the furniture drive at the same time. In general, the at least one further installation stop can also be used both for the depth setting and for the height setting.

According to a preferred embodiment of the present invention, the covering cap comprises two longitudinal edges oriented parallel to each other. At least one of the two longitudinal edges is arranged directly adjoining an inclined surface of the covering cap for the contacting with a furniture carcass top panel.

Through two longitudinal edges oriented parallel to each other, it can be guaranteed that the furniture drive is aligned parallel to the furniture carcass top panel. Through the inclined surface of the covering cap, a jamming of the covering cap between the furniture carcass and the drive unit is prevented, and the risk of scratching during a removal after the drive unit has been installed on the furniture carcass is stopped. Through the inclined surface, the covering cap does not contact the furniture carcass over the surface but rather linearly (or at least via two spatially separate contacting points).

Particularly preferably, the further installation stop, preferably in the area of an axis of symmetry, has at least one cutout, through which the further installation stop is elastically deformable at least in areas between a starting state and a state that is in particular horizontally or vertically compressed in the use position.

The elastic deformability or flexibility at least in areas can be provided by the at least one cutout, wherein in particular a sufficient strength or stability can be guaranteed for the positionally stable positioning on the drive unit.

According to an advantageous design of the invention, the at least one cutout is provided for the arrangement on the drive unit and/or removal from the drive unit and/or is designed deltoid-shaped, triangular, rectangular, or parallelogram-shaped and/or at least three cutouts are provided.

The at least one cutout is provided for the generation of a flexibility of the at least one further furniture stop, wherein at the same time a sufficient stability of the at least one further furniture stop can be guaranteed in order to prevent an undesired release from the drive unit. The at least one cutout acts as an energy storage mechanism, which brings about a positionally stable positioning on the furniture drive and is compressible for removal.

In an embodiment, advantageously at least one, preferably at least or precisely two and/or connected to the further installation stop in a material-bonding manner, spring clip is provided for clipping the further installation stop onto the drive unit of the furniture drive.

Through the at least one spring clip, a user-friendly and quick preinstallation of the at least one further furniture stop is made possible, wherein the at least one further furniture stop can be conveniently fitted onto the drive unit.

It has proved to be favorable that at least one fastening mechanism, spaced apart from the at least one spring clip, is provided for the connection to the drive unit.

A further furniture stop with defined alignment that is firmly arranged on the furniture drive can thereby be generated.

According to an advantageous embodiment of the invention, the further installation stop is formed from plastic, and preferably the further installation stop is formed substantially mirror-symmetrical.

Because of the material-specific characteristics, plastic is suitable for elastically deformable components, which can be produced, for example, as injection-molded parts.

It has proved to be advantageous that the further installation stop comprises at least one actuation area, preferably precisely two arranged symmetrically with respect to each other, with which the further installation stop is manually elastically deformable through the at least one cutout and/or via at least one possibly present spring clip for removing the further installation stop from the drive unit.

The at least one actuation area preferably comprises grip means in the form of a profiling or nubs for improved manual handling. Two actuation areas are preferably provided on the outside of lateral surfaces of the at least one further installation stop. At least one actuation area is preferably formed as an indentation in an outer contour of the at least one further installation stop.

Particularly preferably, at least one second locating point for setting the height of the drive unit relative to a furniture carcass top panel is provided.

Both the height setting and the depth setting can thereby be effected via a component part.

### BRIEF DESCRIPTION OF THE DRAWINGS

The features of the device claims can be used in the method claims and the use claim, and vice versa. Further details and advantages of the present invention will be explained in more detail below with reference to the drawings, in which:

FIGS. 1a, 1b show a furniture drive during an installation on a furniture carcass to illustrate a preferred installation method via a covering cap in a perspective view with an enlarged detail section before the furniture drive has been installed, show the furniture drive with the covering cap in FIGS. 2a, 2b two different positions of the covering cap during the installation method in a perspective view,

FIGS. 3a-3c are enlarged detail section views of the furniture drive and the covering cap during the installation method in the function as installation stop and as cover of a lateral visible area of the furniture drive,

FIGS. 4a, 4b show a furniture carcass with a furniture drive arranged on a furniture carcass side wall with one or two further furniture stops in a perspective view,

FIGS. 5a, 5b show a furniture drive according to a preferred embodiment with two further furniture stops arranged on a drive unit in a perspective view as well as a further furniture stop according to a preferred embodiment in four orthogonal views,

FIGS. 6a, 6b show a further furniture stop according to two further preferred embodiments, in each case in a perspective view and four orthogonal views, shows a furniture drive according to a further FIG. 7 preferred embodiment with two further furniture stops arranged on a drive unit in a perspective view and two orthogonal views.

### DETAILED DESCRIPTION OF THE INVENTION

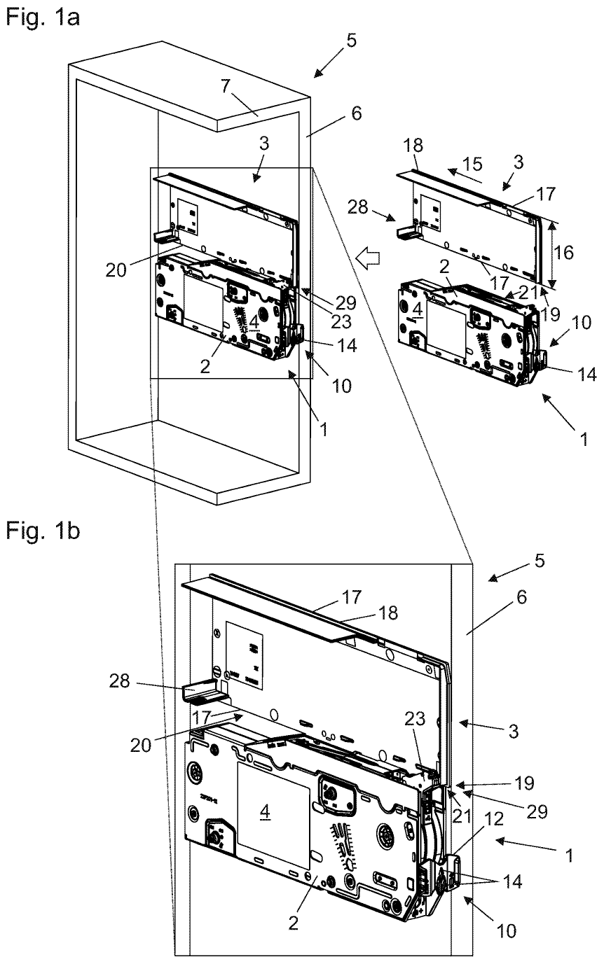

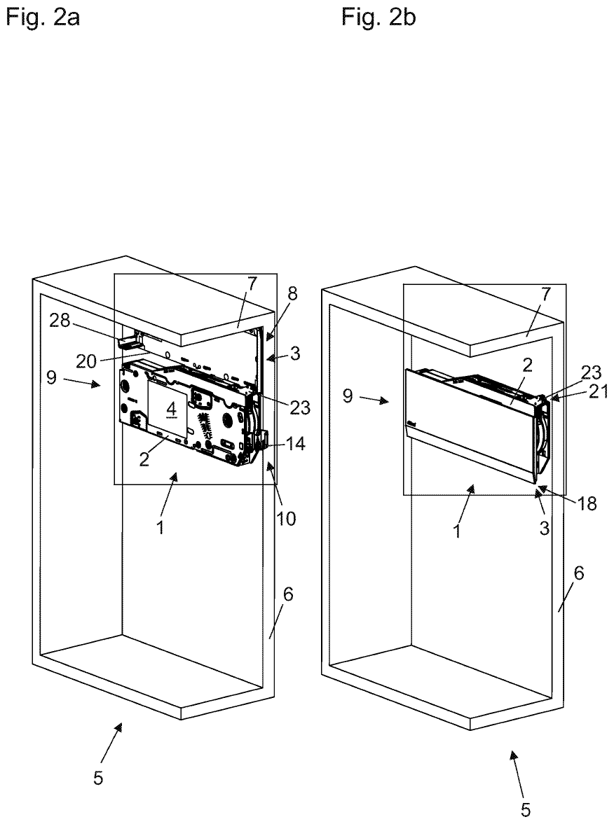

With reference to FIG. 1a to FIG. 3c, a method for installing a furniture drive 1, comprising a drive unit 2 and a covering cap 3 for covering a lateral visible area 4 of the furniture drive 1, on a furniture carcass 5 with a furniture carcass side wall 6 and a furniture carcass top panel 7 can be explained as follows: the covering cap 3 is moved into a position in which the covering cap 3 contacts the furniture carcass top panel 7 and the furniture carcass side wall 6 linearly, with the result that the covering cap 3 forms an installation stop 8 for the furniture drive 1 for the height setting. The drive unit 2 is then moved into a position in which the drive unit 2 contacts the covering cap 3 arranged against the furniture carcass top panel 7 over the surface, with the result that the drive unit 2 is positioned, in terms of height, in a prespecified installation position 9 on the furniture carcass 5.

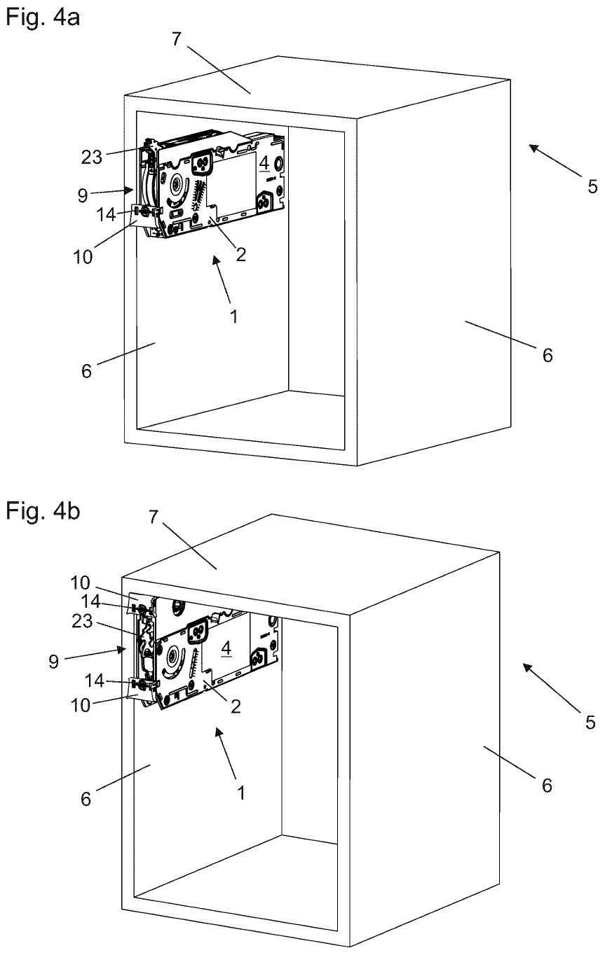

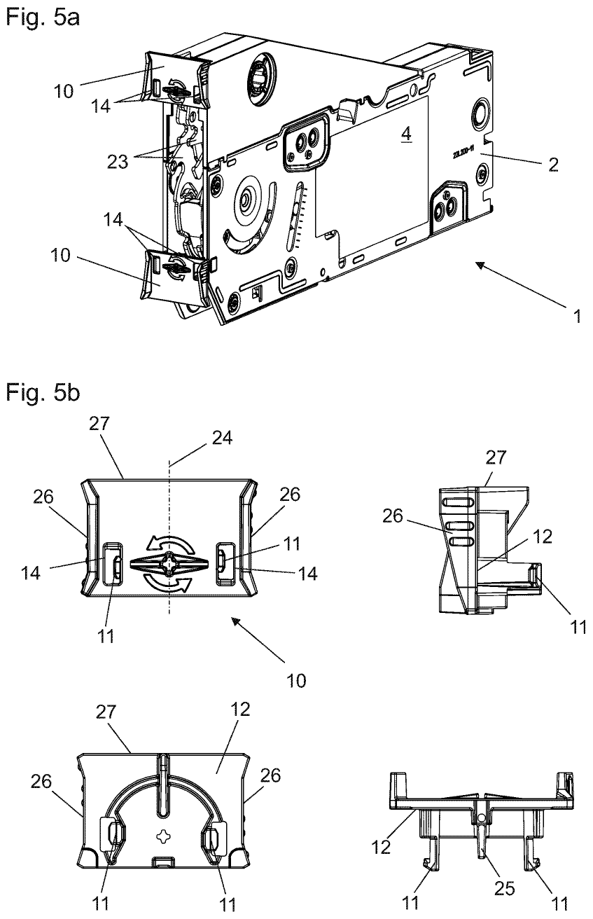

As can be seen in FIG. 1a, on the furniture drive 1, a further installation stop 10 is releasably fastened to the drive unit 2 via two spring clips 11 arranged on the further installation stop 10 (see FIG. 4b to FIG. 5b). The drive unit 2 is moved into a position in which the further installation stop 10 contacts the furniture carcass side wall 6 via a first locating point 12 for the depth setting, with the result that the drive unit 2 is positioned, in terms of depth, in a prespecified installation position 9 on the furniture carcass 5. FIG. 1b shows the relative arrangement between covering cap 3 and drive unit 2 represented enlarged after depth setting has taken place and before a height setting.

The prespecified installation position 9 is not visible or predefined on the furniture carcass, wherein the prespecified installation position 9 clearly results from and is clearly determined by the height setting via the covering cap 3 as well as the depth setting via the further installation stop 10.

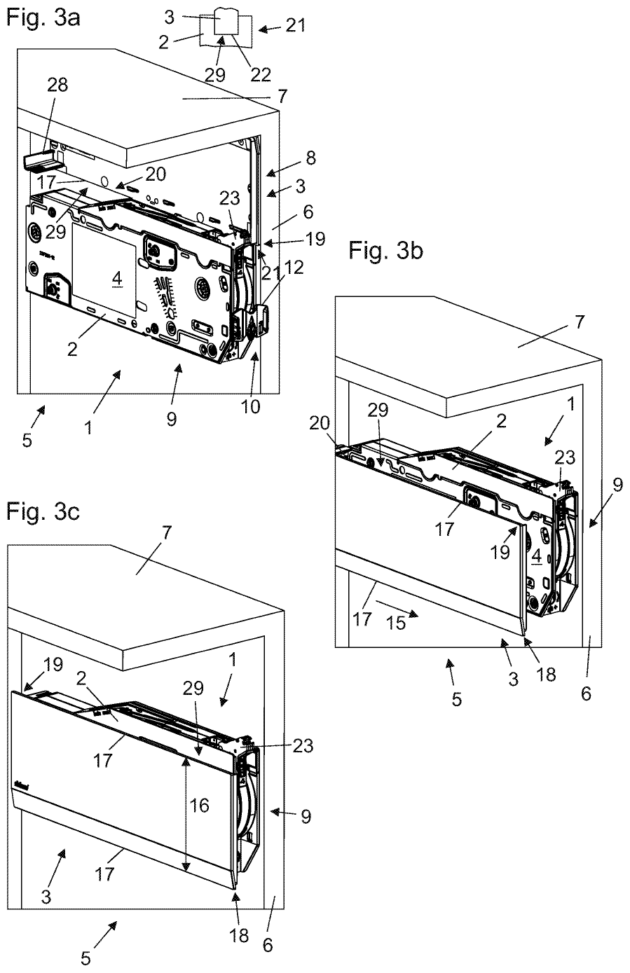

FIG. 2a shows that the drive unit 2 is fastened to the furniture carcass 5 in the prespecified installation position 9 by means of fastening means in the form of a screw connection as soon as the furniture drive 1 is in the prespecified installation position 9 (the rectangular border serves as a reference for FIG. 3a to FIG. 3c). The height setting for the furniture drive 1 was also effected via the covering cap 3, with the result that the furniture drive is fixed to the furniture carcass 5 and the second function of the covering cap 3 can be utilized and the further installation stop 10 can also be removed.

FIG. 2b shows that the further installation stop 10 is removed from the drive unit 2 after the furniture drive 1 has been fastened to the furniture carcass 5, wherein the further installation stop 10 is elastically deformed for the removal via at least one cutout 14 (cf. FIG. 4b to FIG. 5b). The further installation stop 10 is removable for the elastic deformation for the non-destructive removal from the drive unit 2, wherein it is not necessary to disassemble the furniture drive 1.

The covering cap 3 can be arranged on the lateral visible area 4 of the furniture drive 1, in the area of the drive unit 2, after the furniture drive 1 has been fastened to the furniture carcass 5, wherein the covering cap 3 is pivoted from the furniture carcass side wall 6, through 180° relative to a longitudinal extent 15 of the covering cap 3, onto the furniture drive 1.

FIG. 3a shows that, in the use position (during the installation as well as subsequently during an operation), the covering cap 3 is fastened to the furniture drive 1 and the furniture drive 1 is fastened to the furniture carcass 5. The covering cap 3 has a height 16, which corresponds exactly to a vertical spacing of the drive unit 2 from the furniture carcass top panel 7 for a positioning of the drive unit 2 in the prespecified installation position 9.

The covering cap 3 comprises two longitudinal edges 17 oriented parallel to each other, with which the drive unit 2 is aligned parallel to the furniture carcass top panel 7 during the installation.

One of the two longitudinal edges 17 directly adjoins an inclined surface 18 (on the front side for the linear contacting with the furniture carcass top panel 7) of the covering cap 3 and contacts the furniture carcass top panel 7, as a result of which a release of the covering cap 3 after the furniture drive 1 has been fastened to the furniture carcass 5 is made easier and damage to the furniture carcass 5 is prevented.

For the contact of the furniture drive 1 against the covering cap 3, the drive unit comprises an adjustment device 21, which is designed as an indentation 22 (which is schematically represented in an enlarged detail section, and which can for example also be formed with only one lateral stop for the covering cap 3). The covering cap 3 has a bar 19, which protrudes from an underside 20 aligned parallel to the drive unit 2 during the installation and in the use state of the furniture drive 1. The bar 19 is arranged inside the indentation 22 during the installation.

FIG. 3b shows that the covering cap 3, even irrespective of the structural design of the covering cap 3, from an installation position in which the covering cap 3 is arranged parallel above the drive unit 2, can be arranged in an operating position in which the covering cap 3 is positioned parallel, to the side of the drive unit 2.

Accordingly, the covering cap 3, in addition to the function as a cover for the lateral visible area 4 of the drive unit, is used as an installation stop 8 or as a gage for the installation of the furniture drive 1 on the furniture carcass 5.

FIG. 3c shows an installation arrangement according to a preferred embodiment consisting of a furniture drive 1 for moving a movably mounted furniture part relative to the furniture carcass 5, comprising the drive unit 2 and the covering cap 3, and a furniture carcass 5 with the furniture carcass side wall 6 and the furniture carcass top panel 7.

The covering cap 3 is arranged linearly against the furniture carcass top panel 7 and the drive unit 2 is arranged flat against the covering cap 3 for the height setting during the installation of the drive unit 2 on the furniture carcass 5.

A further installation stop 10 which can be attached to the furniture carcass 5 is arranged on the drive unit 2, wherein the further installation stop 10 is preinstalled releasably on the drive unit 2 and is removable from the furniture drive 1 via a clip connection after installation has taken place.

The covering cap 3 has the height 16, which corresponds exactly to the desired spacing of the drive unit 2 from the furniture carcass top panel 7 for the positioning of the drive unit 2 in the prespecified installation position 9.

The covering cap 3 is arranged flat against the furniture carcass side wall 6.

FIG. 4a and FIG. 4b show a furniture carcass 5 with a furniture drive 1 installed thereon, wherein in general in each case two furniture drives 1 can also be provided on the furniture carcass 5 for moving a furniture part (not visible in the representation) arranged so as to be movable in an articulated manner on the furniture carcass 5.

The furniture drive 1 can be seen in FIG. 4a during an installation on the furniture carcass side wall 6. The covering cap 3 (not visible in the representation) can be arranged between the furniture drive 1 and the furniture carcass top panel 7, in order to arrange the furniture drive 1 at a defined and parallel spacing from the furniture carcass top panel 7 for the height setting.

Before or after the height adjustment, the further installation stop 10 can be used in order to generate the depth setting via a contacting of the further installation stop 10 with the furniture carcass side wall 6.

The furniture drive 1 with two further installation stops 10 can be seen in FIG. 4b, wherein the height setting was effected via the upper further installation stop 10. The depth setting is generated by the lower installation stop 10, wherein a parallel alignment of the furniture drive 1 is ensured by the upper installation stop 10. However, two further installation stops 10—in particular for the depth setting—are generally not strictly necessary.

FIG. 5a shows a furniture drive 1 with a drive unit 2, wherein a lateral visible area 4 of the furniture drive 1 is at least partially concealed by the covering cap 3 after installation of the covering cap 3 on the furniture carcass 5.

Two further installation stops 10 are arranged on the end face of the drive unit 2. The lower further installation stop 10 in the use location is used for the depth setting. The upper further installation stop 10 in the use location can be used for the height setting, wherein it can also be removed before an installation of the furniture drive 1 on the furniture carcass 5, in order to effect the height setting via the covering cap 3—in particular with a height setting altered with respect to this further furniture stop 10.

The force for moving movable furniture parts is provided by the drive unit 2, wherein for example energy storage mechanisms can be provided inside the drive unit 2. The furniture drive 1 comprises two actuators 23 for moving the movable furniture part by the application of force via the drive unit 2. Movement kinematics can for example be influenced by a lever mechanism in connection with at least one actuator 23.

FIG. 5b shows a first preferred embodiment of a further installation stop 10 for the depth and/or height setting, wherein the further installation stop 10 can be provided for the installation of the furniture drive 1 on or in the furniture carcass 5.

The further installation stop 10 comprises at least one first locating point 12 in the form of a locating surface for setting the depth of the drive unit 2 relative to the furniture carcass side wall 6. The further installation stop 10 is releasably fastenable to the drive unit 2 of the furniture drive 1 (see FIG. 4a) and comprises, in the use location on the front side of the drive unit 2, a tool receiver for a screwdriver, in order to rotate the further installation stop 10 when it is fastened to the drive unit 2.

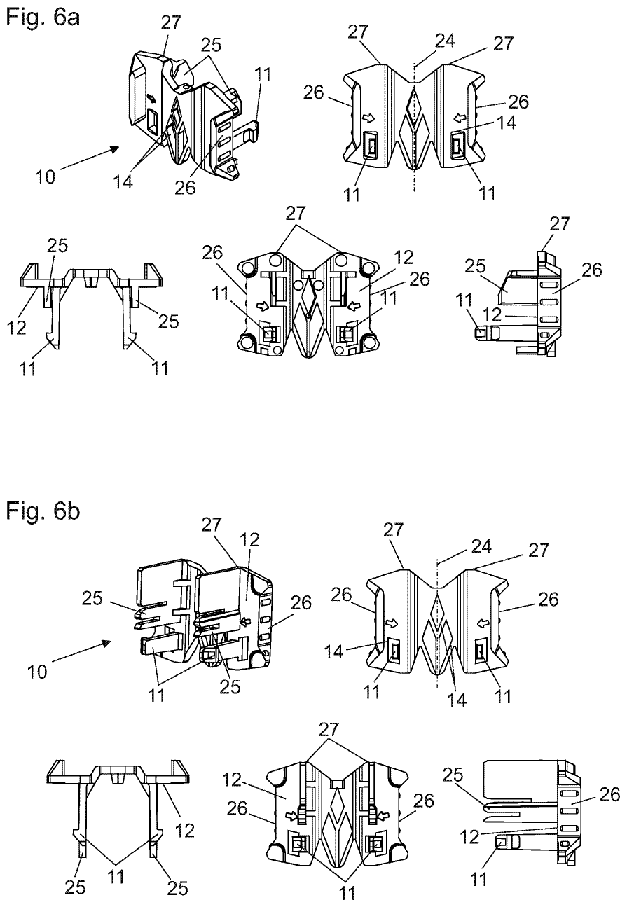

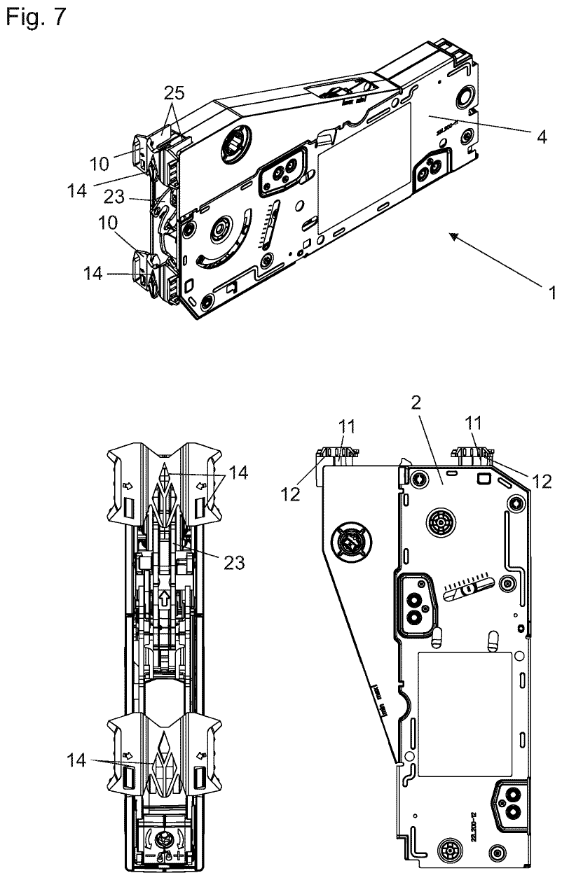

FIG. 6a and FIG. 6b show two further preferred embodiments of a further installation stop 10 for the depth and/or height setting.

FIG. 6a shows that the further installation stop 10, in the area of the axis of symmetry 24, has a plurality of cutouts 14, through which the further installation stop 10 is elastically deformable between a starting state, visible in the representation, and a state that is horizontally compressed in the use position.

The cutouts 14 for the arrangement on the drive unit 2 are provided for the removal from the drive unit 2. In the figure, the upper cutout 14 is formed parallelogram-shaped, the two lower cutouts 14 are formed triangular and the middle cutouts 14 are formed deltoid-shaped.

Three cutouts 14 are designed as openings in the further installation stop 10, wherein the number and geometries are generally as desired.

FIG. 6b shows that two spring clips 11 connected to the further installation stop 10 in a material-bonding manner are provided for clipping the further installation stop 10 onto the drive unit 2 of the furniture drive 1.

The further installation stop 10 comprises two fastening mechanisms 25 connected in a material-bonding manner, which are arranged spaced apart from the two spring clips 11, for the connection to the drive unit 2.

The further installation stop 10 is formed from plastic and mirror-symmetrical.

The further installation stop 10 comprises two actuation areas 26 arranged symmetrically with respect to each other, with which the further installation stop 10 is manually elastically deformable through the cutouts 14 and via the spring clips 11 for removing the further installation stop 10 from the drive unit 2. The actuation areas 26 are arranged on an outer contour of the further installation stop 10 in the form of an indentation with corrugation.

The further installation stop 10 comprises two second locating points 27 for setting the height of the drive unit 2 relative to the furniture carcass top panel 7, wherein in general only one second locating point 27 can also be provided.

FIG. 7 illustrates the arrangement of two further installation stops 10 on the end face of a furniture drive 1 in a perspective view as well as two orthogonal views, wherein one further installation stop 10, in the use location, is arranged in a lower area of the end face and one further installation stop 10, in the use location, projects above a top side of the furniture drive 1. The two further installation stops 10 always project above the end face before removal of the further installation stops 10.

1. A method for installing a furniture drive including a drive unit and a covering cap for covering a lateral visible area of the furniture drive at least in areas, on a furniture carcass with a furniture carcass side wall and a furniture carcass top panel, the method comprising, in particular to be carried out in chronological order:
moving the covering cap into a position in which the covering cap contacts the furniture carcass top panel and possibly the furniture carcass side wall, with the result that the covering cap forms an installation stop for the furniture drive for the height setting,
moving the drive unit into a position in which the drive unit contacts the covering cap preferably arranged against the furniture carcass top panel, and
with the result that the drive unit is arranged at a predetermined vertical distance from the furniture carcass top panel in a prespecified installation position on the furniture carcass.

2. The method according to claim 1, wherein, on the furniture drive, at least one further installation stop is releasably fastened to the drive unit, preferably via at least one spring clip arranged on the at least one further installation stop, and the drive unit is moved into a position in which the at least one further installation stop contacts the furniture carcass side wall via at least one first locating point for the depth setting, with the result that the drive unit is positioned, in terms of depth, in a prespecified installation position on the furniture carcass.

3. The method according to claim 1, wherein the drive unit is fastened to the furniture carcass in the prespecified installation position, preferably by means of at least one fastening means such as a screw or dowel, wherein it is preferably provided that the at least one fastening means is inserted into an opening of the drive unit in the course of the installation of the furniture drive, in order to connect the furniture drive to the furniture carcass side wall.

4. The method according to claim 2, wherein the at least one further installation stop is removed from the drive unit after the furniture drive has been fastened to the furniture carcass, wherein it is preferably provided that the at least one further installation stop is elastically deformed for the removal via at least one cutout.

5. The method according to claim 1, wherein the covering cap is arranged at least in areas on the lateral visible area of the furniture drive, preferably on the drive unit, after the furniture drive has been fastened to the furniture carcass, wherein it is preferably provided that the covering cap is pivoted from the furniture carcass side wall, substantially through 180° relative to a longitudinal extent of the covering cap, onto the furniture drive and/or, from an installation position in which the covering cap is arranged parallel above the drive unit, is arranged in an operating position in which the covering cap is positioned, preferably parallel, to the side of the drive unit.

6. The method according to claim 1, wherein the covering cap is adapted such that the covering cap has a height in the use position of the furniture drive on the furniture carcass, which corresponds exactly to a spacing of the drive unit from the furniture carcass top panel for a positioning of the drive unit in the prespecified installation position.

7. The method according to claim 1, wherein the covering cap has two longitudinal edges oriented parallel to each other, with which the drive unit is aligned parallel to the furniture carcass top panel, wherein it is preferably provided that at least one of the two longitudinal edges is arranged directly adjoining an inclined surface of the covering cap and/or against the furniture carcass top panel for the removal of the covering cap after the furniture drive has been fastened to the furniture carcass.

8. The method according to claim 1, wherein the covering cap has a bar and/or an underside aligned parallel to the drive unit during the installation of the furniture drive, which is arranged at least in areas in an adjustment device, preferably indentation, of the drive unit.

9. The method according to claim 1, wherein the covering cap contacts the furniture carcass top panel and/or the furniture carcass side wall linearly, via at least two contacting points spaced apart from each other and/or over the surface and/or the drive unit contacts the covering cap linearly, via at least two contacting points spaced apart from each other and/or over the surface.

10. A use of a covering cap of a furniture drive, in particular flap drive, as an installation stop for installing the furniture drive on a furniture carcass.

11. An installation arrangement consisting of at least one furniture drive, in particular flap drive, for moving a movably mounted furniture part relative to a furniture carcass, comprising a drive unit and a covering cap, and a furniture carcass with a furniture carcass side wall and a furniture carcass top panel, wherein the covering cap is arranged against the furniture carcass top panel and the drive unit is arranged on the covering cap for the height setting during an installation of the drive unit on the furniture carcass at a predetermined vertical distance from the furniture carcass top panel in a prespecified installation position.

12. The installation arrangement according to claim 11, wherein the furniture drive comprises an actuator for moving the movable furniture part by the application of force via the drive unit and/or the covering cap is arranged preferably flat against the furniture carcass side wall.

13. The installation arrangement according to claim 11, wherein the covering cap has a bar and/or an underside aligned parallel to the drive unit, which is arranged at least in areas in an adjustment device, preferably indentation, of the drive unit, wherein it is preferably provided that the covering cap, from an installation position in which the covering cap is arranged parallel above the drive unit, can be arranged in an operating position in which the covering cap is positioned, preferably parallel, to the side of the drive unit.

14. The installation arrangement according to claim 11, wherein the covering cap has two longitudinal edges oriented parallel to each other, wherein it is preferably provided that at least one of the two longitudinal edges is arranged directly adjoining an inclined surface of the covering cap and/or against the furniture carcass top panel.

15. The installation arrangement according to claim 11, wherein at least one further installation stop which can be attached to the furniture carcass is provided on the at least one drive unit, wherein the at least one further installation stop is preinstalled releasably on the drive unit.

16. The installation arrangement according to claim 11, wherein the covering cap has a height in the use position of the furniture drive on the furniture carcass, which corresponds exactly to a spacing of the drive unit from the furniture carcass top panel for a positioning of the drive unit in the prespecified installation position.

17. The installation arrangement according to claim 11, wherein the covering cap contacts the furniture carcass top panel and/or the furniture carcass side wall linearly, via at least two contacting points spaced apart from each other and/or over the surface and/or the drive unit contacts the covering cap linearly, via at least two contacting points spaced apart from each other and/or over the surface.

18. A covering cap for installing a furniture drive, in particular flap drive, on a furniture carcass, wherein the covering cap comprises at least one fastening device for arranging the covering cap in an operating position in which the covering cap is arranged, preferably parallel, in the use position, to the side of a drive unit and an adjustment means for arranging the covering cap in a further operating position in which the covering cap is arranged in an adjustment device of the drive unit, in the use position, above the drive unit.

19. The covering cap according to claim 18, wherein the covering cap comprises two longitudinal edges oriented parallel to each other, wherein at least one of the two longitudinal edges is arranged directly adjoining an inclined surface of the covering cap for the contacting with a furniture carcass top panel.

20. A further installation stop for installing a furniture drive, in particular flap drive, on or in a furniture carcass, comprising at least one first locating point for the depth setting of the drive unit relative to a furniture carcass side wall, wherein the further installation stop is releasably fastenable to a drive unit of the furniture drive and is elastically deformable at least in areas for the non-destructive removal from the drive unit.

21. The further installation stop according to claim 20, wherein the further installation stop, preferably in the area of an axis of symmetry, has at least one cutout, through which the further installation stop is elastically deformable at least in areas between a starting state and a state that is in particular horizontally or vertically compressed in the use position.

22. The further installation stop according to claim 20, wherein the at least one cutout is provided for the arrangement on the drive unit and/or removal from the drive unit and/or is designed deltoid-shaped, triangular, rectangular or parallelogram-shaped and/or at least three cutouts are provided.

23. The further installation stop according to claim 20, wherein at least one, preferably at least or precisely two and/or connected to the further installation stop in a material-bonding manner, spring clip is provided for clipping the further installation stop onto the drive unit of the furniture drive.

24. The further installation stop according to claim 20, wherein at least one fastening mechanism, spaced apart from the at least one spring clip, is provided for the connection to the drive unit.

25. The further installation stop according to claim 20, wherein the further installation stop is formed from plastic, wherein it is preferably provided that the further installation stop is formed substantially mirror-symmetrical.

26. The further installation stop according to claim 20, wherein the further installation stop comprises at least one actuation area, preferably precisely two arranged symmetrically with respect to each other, with which the further installation stop is manually elastically deformable through the at least one cutout and/or via at least one possibly present spring clip for removing the further installation stop from the drive unit.

27. The further installation stop according to claim 20, wherein at least one second locating point for setting the height of the drive unit relative to a furniture carcass top panel is provided.
